(19) United States
(12) Patent Application Publication
(10) Pub. No.: US 2006/0113032 A1
(43) Pub. Date: Jun. 1, 2006

(54) Method for manufacturing printed wiring board

(76) Inventor: Keiichi Murakami, Komaki-shi Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/538,506

(22) PCT Filed: Dec. 9, 2002
(86) PCT No.: PCT/JP02/12844

§ 371 Date: Jun. 9, 2005

(51) Int. Cl. B29C 65/00

(52) U.S. Cl. 156/295; 156/285

(57) ABSTRACT

There is provided a method for manufacturing a printed wiring board, including the following steps. Forming a resin layer on a printed wiring board with circuit patterns formed thereon wherein the resin layer is formed by superposing a semi-cured resin sheet, in which patterns complementary to the circuit patterns are included on a surface of the resin sheet facing the circuit patterns. Pressing and forcing the resin layer into spaces between the circuit patterns and curing the resin layer. And then polishing the cured resin covering said circuit patterns, thereby exposing said circuit patterns.

### TECHNICAL FIELD

The present invention relates to a method for manufacturing a printed wiring board of which the surface of the board is flattened.

### BACKGROUND ART

In the case of manufacturing a multi-layer printed wiring board by e.g. a build-up method, it is necessary to flatten the surfaces of a lower layer substrate in order to increase the wiring density of the assembly. However, the circuit pattern of a printed board, which may be manufactured by a subtractive method for removing unnecessary amounts of copper foil via etching, is generally formed into an uneven configuration in which the circuit pattern portion is slightly raised above the surrounding surface of the base material.

Therefore, in order to flatten a printed board containing a surface formed into an uneven form as described above, the following method has been proposed. For example, there has been proposed a method comprising the steps of: laminating a semi-cured resin sheet onto circuit patterns; pressing the resin sheet in a reduced pressure atmosphere via a smoothing plate, so as to cause the resin to flow into the spaces between the circuit patterns; curing the resin; and then polishing with a planer to shape the surface of the resin.

However, the resin layer may not be formed uniformly and adequately because of the presence of sparse or dense sections of circuit patterns on the substrate, and the presence or absence of through holes, etc. For example, in the sections where the circuit patterns are dense, the resin sheet tends to be difficult to force into spaces between the circuit patterns. As a result, the remaining unfilled spaces may cause voids to be produced in subsequent processing. In addition, considerably thick resin may remain on top of the circuit patterns and cause the surface of the resin layer to become uneven. Consequently, the resin layer may form a gradually raised configuration at locations where the circuit patterns are densely formed. On the contrary, in the areas where the circuit patterns are sparse and where through holes are formed, the amount of resin may be insufficient as compared with other areas of the printed wiring board. As a result, the surface of the resin layer may be formed into a gradually recessed configuration. In such a situation, the resin layer is hardly uniformly formed across the whole surface, even after having been pressed via a smoothing plate. A substrate having such gradually rising and falling sections can also be difficult to polish accurately and flatly.

The present invention has been made in view of the above described circumstances. An object of the present invention is to provide a method for manufacturing a printed wiring board that makes it possible to form a resin layer having uniform and beneficial characteristics over the entire surface of the wiring board. This object is regardless of the sparseness or density of the parts or sections of circuit patterns and also regardless of the presence or absence of through holes.

### DISCLOSURE OF THE INVENTION

In order to address the above described problems, according to the present invention there is provided a method for manufacturing a printed wiring board, including the steps of: forming a resin layer by superposing a semi-cured resin sheet onto a printed wiring board with circuit patterns formed thereon; pressing and forcing the resin layer into the spaces between the circuit patterns; curing the resin layer; and then polishing the cured resin layer, thereby exposing the circuit patterns. A resin pattern complementary to the circuit patterns is prepared and included on the surface of the semi-cured resin sheet prior to superposing the semi-cured resin sheet onto the printed wiring board. The complementary resin patterns of the semi-cured resin sheet are superposed onto the printed wiring board facing the circuit patterns.

There is also provided a method for manufacturing a printed wiring board, including the steps of: forming a resin layer by superposing a semi-cured resin sheet on a printed wiring board where through holes and circuit patterns are formed; pressing and forcing the resin layer into the spaces between the circuit patterns; curing the resin layer; and then polishing the cured resin layer, thereby exposing the circuit patterns. Additional resin required for filling the interior of the through holes is located at positions of the semi-cured resin sheet corresponding to the locations of the through holes, prior to superposing the semi-cured resin sheet onto the printed wiring board.

The pressing against the resin layer may be performed in a reduced pressure atmosphere. A metallic foil with a roughened surface facing the resin layer may also be superposed and pressed against the resin layer. In this case, the metallic foil may be formed from a metal of a different kind than the metal used for the circuit patterns.

According to the present invention, since the resin layer is pressed, even if the resin layer is gradually raised at a part where the circuit patterns are formed thereunder, the raised part is compressed so that the resin layer as a whole is made to thinly and evenly spread. Even if sparse and dense parts are present in the circuit patterns on the substrate, a semi-cured resin sheet with resin patterns complementary to the circuit patterns may be created beforehand. The resin patterns are located on the surface of the semi-cured resin sheet facing the circuit patterns, so that the resin layer as a whole is made to be substantially uniform regardless of the sparse and dense state of the circuit patterns. Since only a relatively thin resin layer remains on the circuit patterns when the resin is cured in this state, it is possible to obtain a substantially flat substrate with the circuit patterns exposed by polishing the circuit patterns at a strength that will not damage the circuit patterns.

In the case of the substrate having through holes, locating additional resin beforehand at the positions of the semi-cured resin sheet corresponding to the through holes allows the entire resin layer on the substrate to be uniformly formed without causing a deficiency of resin proximate to the through holes.

If air bubbles are contained within the resin layer, the air bubbles may be removed by performing the pressing of the resin layer in a reduced pressure atmosphere.

Further, the metallic foil with a roughened surface facing the resin layer facilitates the thin spreading of the resin layer when the metallic foil is superposed on the resin layer prior to the time of the pressing of the resin layer. The surface of the resin layer is also formed in a fine uneven state corresponding to the roughened surface of the metallic foil. As a result, the residual resin layer can be more easily polished.

Further, in the case where the above described metallic foil is formed with a metal of a different kind than the metal used for the circuit patterns, the metallic foil can be removed by selective etching or dissolving only the metallic foil, without affecting the metal of the circuit patterns.

### BRIEF DESCRIPTION OF THE DRAWINGS

FIG. 1 is a partial sectional view of a copper clad laminated board;

FIG. 2 is a sectional view of the wiring board with circuit patterns formed thereon;

FIG. 3 is a sectional view of a wiring board when resin layers are formed with resin sheets according to a first embodiment of the present invention;

FIG. 4 is a sectional view of the wiring board showing a layout at the time just prior to pressing;

FIG. 5 is a sectional view of the wiring board after the resin is cured;

FIG. 6 is a sectional view of the wiring board after the metallic foil is removed;

FIG. 7 is a sectional view of the wiring board after polishing;

FIG. 8 is a partial sectional view of a wiring board where through holes are formed in the copper clad laminated board;

FIG. 9 is a partial sectional view of the wiring board with a plated layer formed thereon;

FIG. 10 is a sectional view of the wiring board on which circuit patterns are formed;

FIG. 11 is a sectional view of a wiring board when resin layers are formed with resin sheets according to a second embodiment of the present invention;

FIG. 12 is a sectional view of the wiring board showing a layout at the time just prior to pressing;

FIG. 13 is a sectional view of the wiring board after the resin is cured;

FIG. 14 is a sectional view of the wiring board after a metallic foil is removed; and

FIG. 15 is a sectional view of the wiring board after polishing.

### BEST MODE FOR CARRYING OUT THE INVENTION

<First Embodiment>

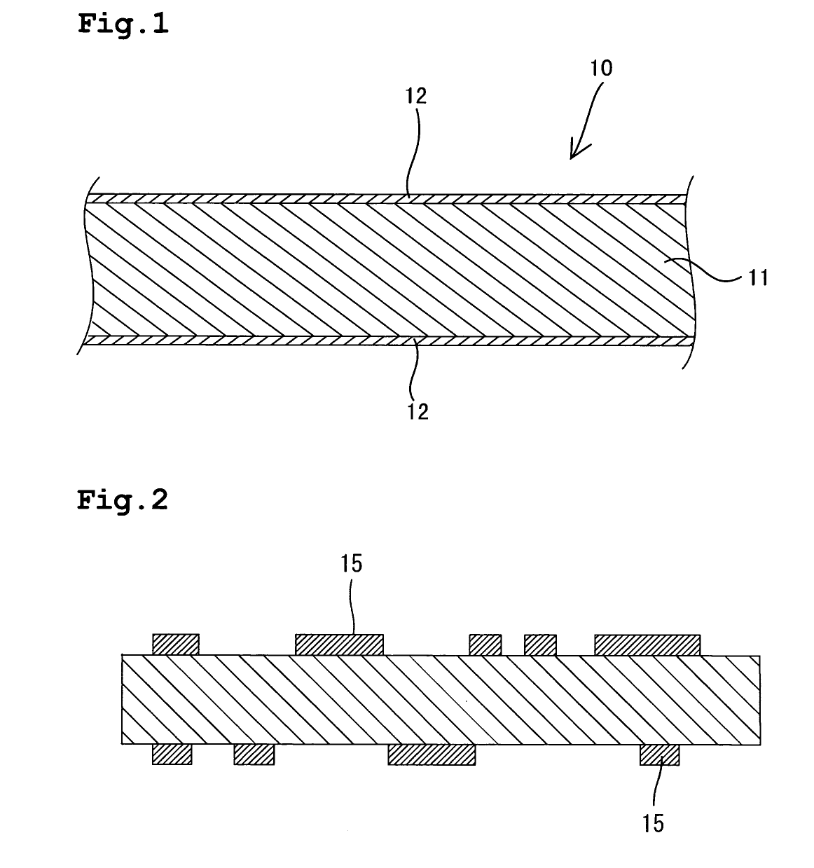

In the present embodiment, as shown in FIG. 1, a copper clad laminated board 10 with copper foils 12 adhered to both sides of a glass epoxy substrate 11 having a thickness of, for example, 100 μm to 3000 μm is used as a base material. Circuit patterns 15 are formed on the copper clad laminated board 10 by a known photo etching method (see FIG. 2).

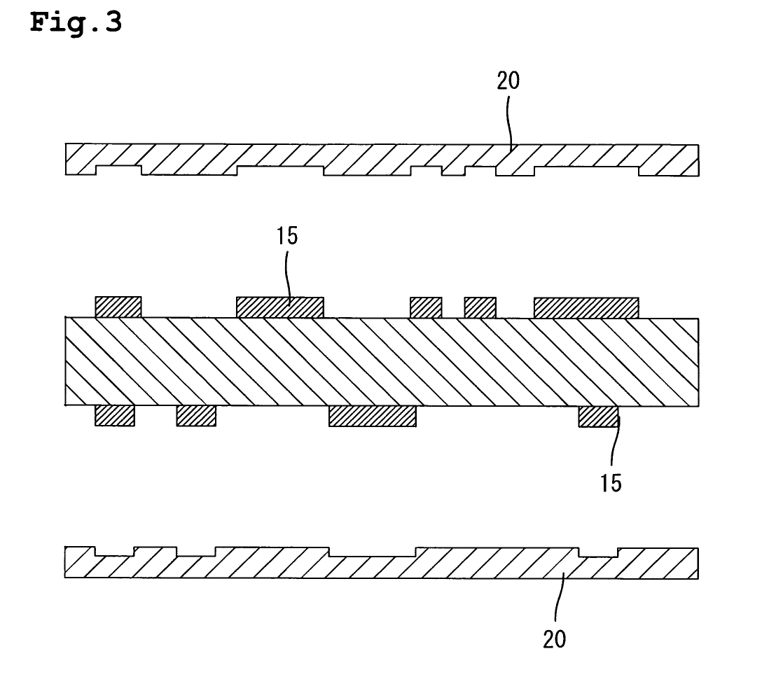

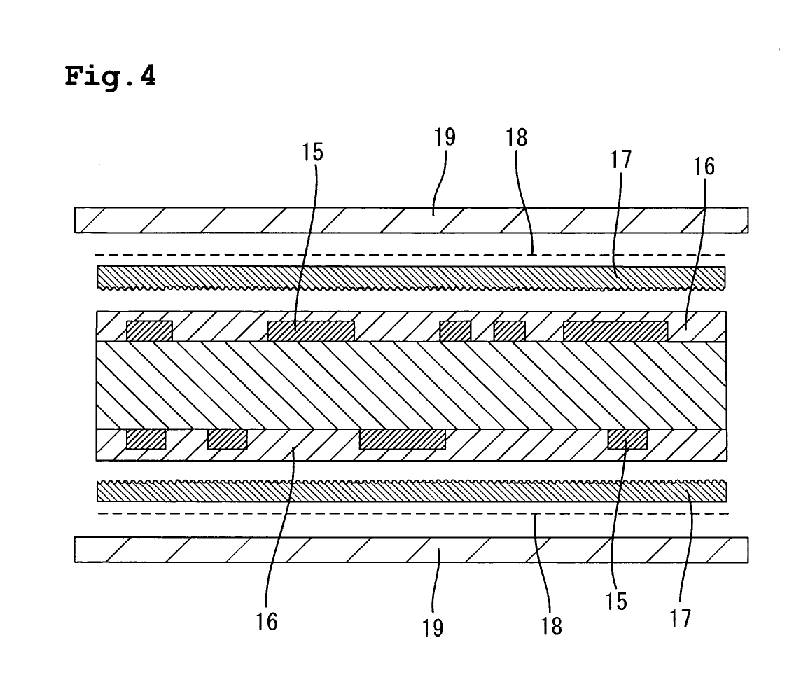

As shown in FIGS. 3 and 4, resin layers 16 (FIG. 4) are formed on the surfaces of the substrate by laminating resin sheets 20 with a thickness of about 30 μm onto the circuit patterns 15 of the wiring board. The resin sheets 20 may be formed of e.g., semi-cured thermosetting epoxy resin. Thermosetting epoxy resin having resin patterns complementary to the circuit patterns 15 are formed beforehand on the surface of the resin sheets 20 facing the circuit patterns 15.

As shown in FIG. 4, nickel foils 17, with a thickness of 18 μm and one face of which is roughened by a needle shaped plating, are placed on the resin layers 16 such that the roughened surface faces or contacts the resin layers 16. Smooth stainless plates 19 with a thickness of about 1 mm are pressed against the substrate at 30 kg/cm² via Teflon sheets 18, as a mold release film, from the outside of the resin layers 16 in a reduced pressure atmosphere. As a result, the surfaces of the resin layers 16, which may range from substantially even to a gradually rising/falling (i.e., undulating) state, are flattened and compressed by the smoothing plates 19. The resin layers 16 are thinly spread across the whole surface. The air bubbles in the resin layers 16 also rise to the vicinity of the surface of the resin layers 16. As a result, the air bubbles are substantially removed from within the interior of the resin.

After the resin layers 16 on the circuit patterns 15 are sufficiently compressed by the pressing of the stainless plates 19 and the air bubbles in the resin are released to the outside, the resin layers 16 are heated in order to be finally cured.

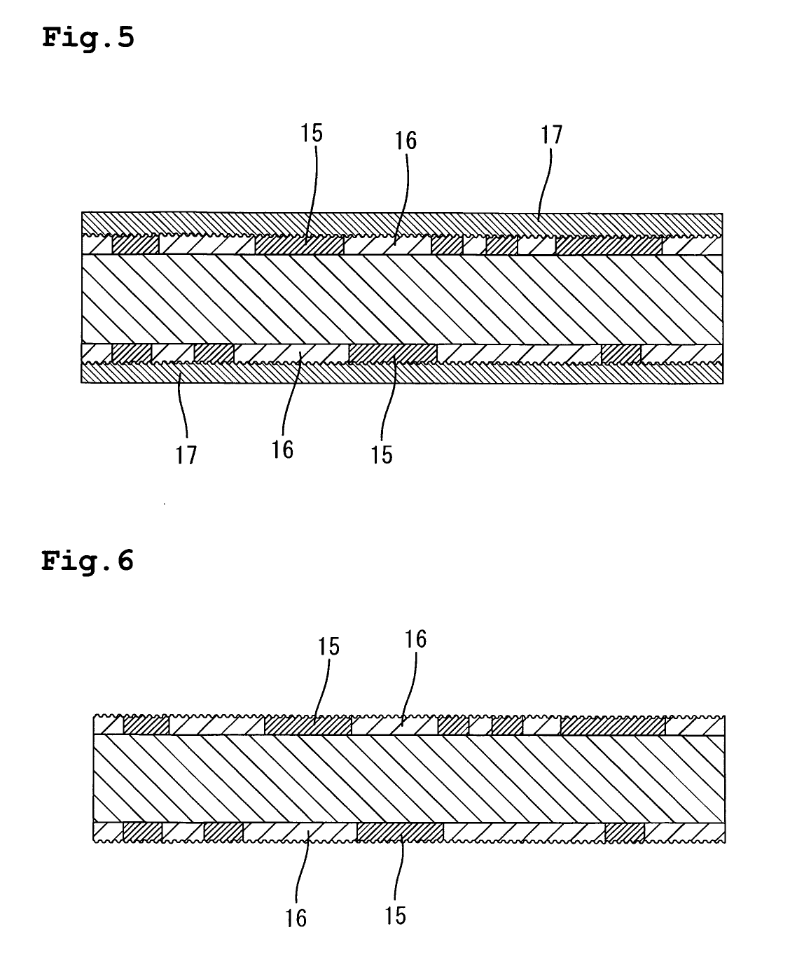

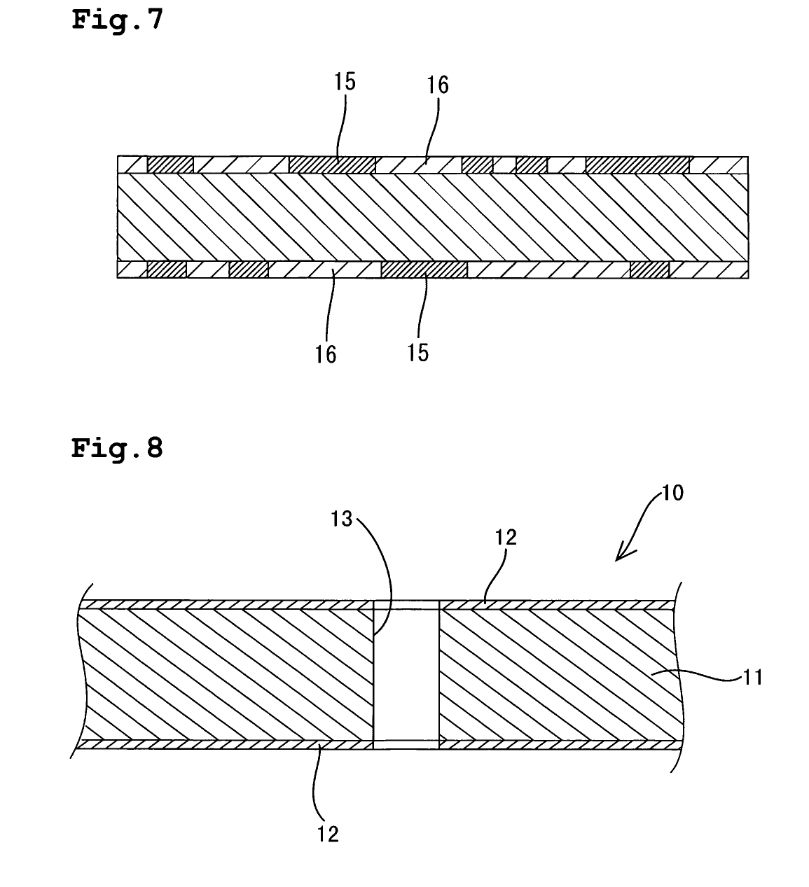

The stainless plates 19 and the Teflon sheets 18 are then removed. The nickel foils 17 adhered to the surface of the resin layers 16 may be removed by an etching solution exclusively used for nickel (see FIGS. 5 and 6). As a result, the resin layers remaining on the copper circuit patterns 15 become 10 μm or less and the surface of the resin is in a roughened state. Then to flatten the substrate, primary smooth surface polishing is performed by ceramic buff polishing in order to remove the resin layers 16 from the circuit patterns 15. Secondary finish polishing is finally performed by means of a surface grinding machine in order to make the average roughness accuracy of the surface become equal to or less than 3 μm (see FIG. 7). In the case of surface polishing, since the resin layers 16 remaining on the circuit patterns 15 have an extremely thin thickness (e.g., 10 μm) and the surface of the resin layers is roughened, the polishing is easily performed.

<Second Embodiment>

Hereafter, a second embodiment according to the present invention is described with reference to FIGS. 8 to 15. The descriptions of common components of the first and second embodiment that have been previously described with regard to the first embodiment are omitted from the description of the second embodiment.

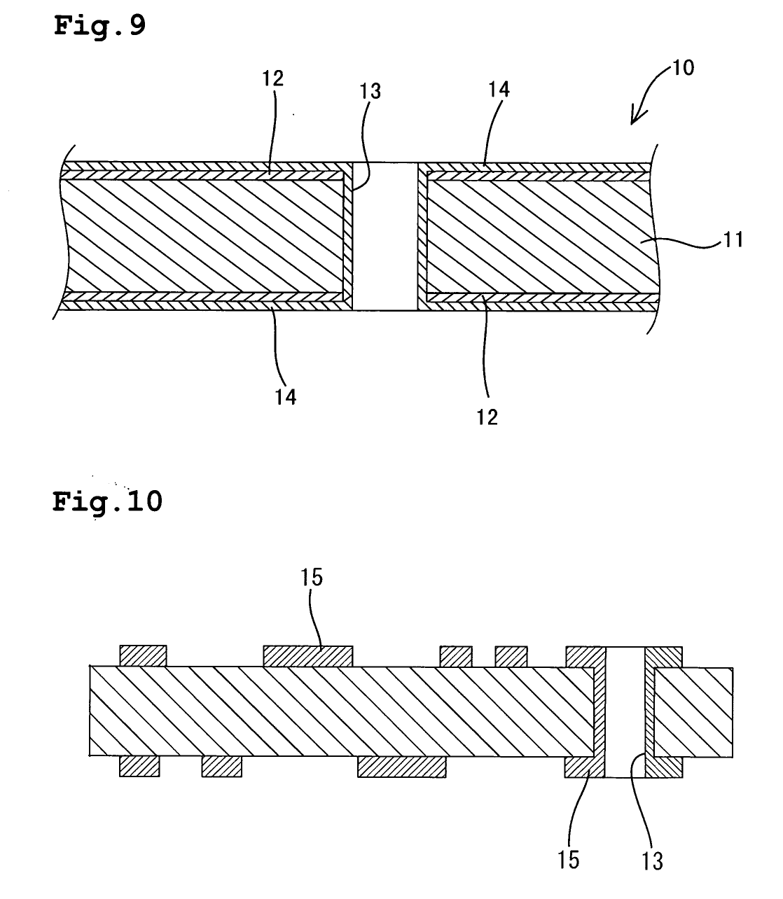

In the present embodiment through holes 13 may be bored by use of a known drill, etc., at required locations of the copper clad laminated board 10 (see FIG. 8). Chemical plating and electrolytic plating are then performed, as in the first embodiment, for forming copper plated layers 14 on the entire surface area, including the inner peripheral face of the through holes 13. This causes the thickness of the conductor layer on the surface of the substrate to become approximately 20 μm (see FIG. 9). A known photo etching method is then used to form the circuit patterns 15 (see FIG. 10).

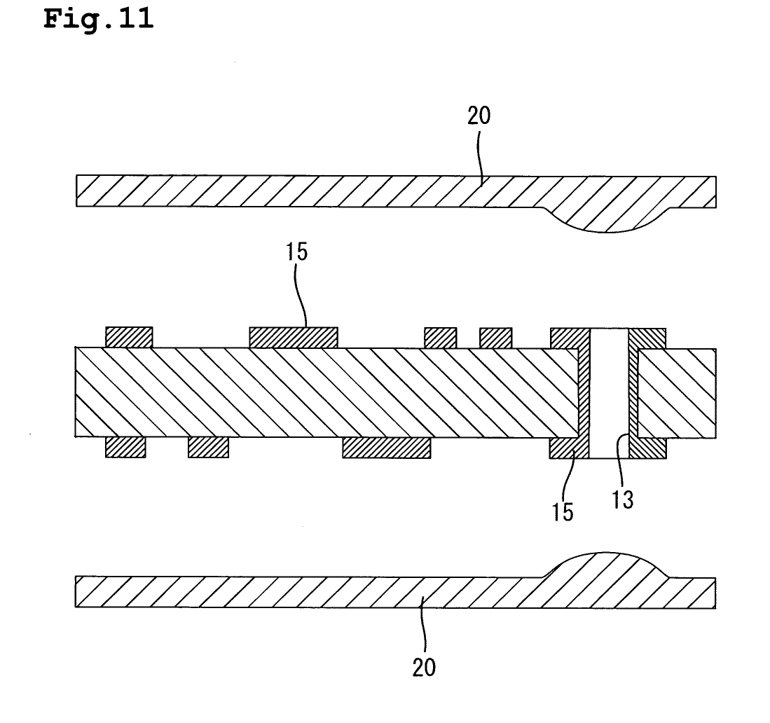

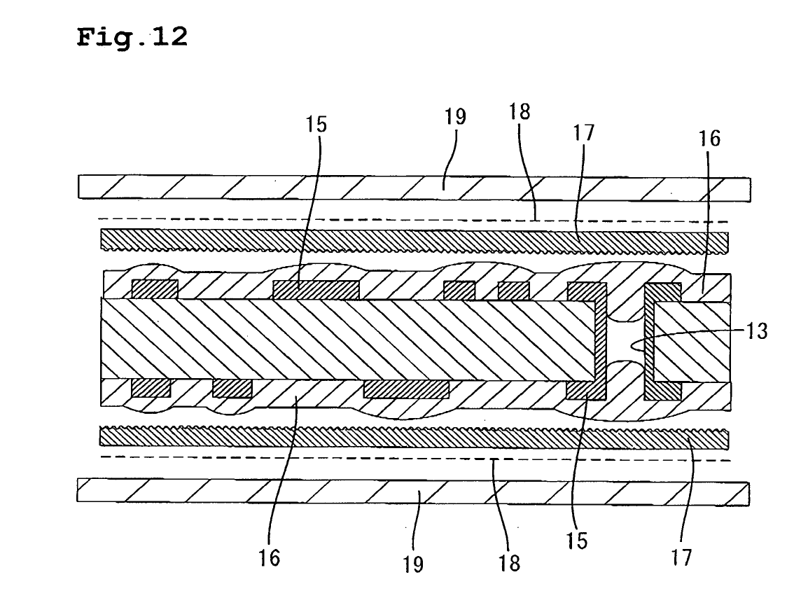

As shown in FIGS. 11 and 12, resin layers 16 (FIG. 12) are formed on the substrate by laminating resin sheets 20 with a thickness of about 30 μm onto the circuit patterns 15 of the wiring board. The resin sheets 20 may be formed from e.g. semi-cured thermosetting epoxy resin. Additional thermosetting epoxy resin for filling the through holes 13 is concentrated beforehand at positions on the resin sheets 20 corresponding to the through holes 13. At this point, the surface of the resin layers 16 may be in a gradually rising/falling (i.e., undulating) state with the raised surfaces corresponding to the circuit pattern 15 sections.

As in the first embodiment, nickel foils 17, with a thickness of 18 μm and one face of which is roughened, are applied to the resin layers 16. Smooth stainless steel plates 19 with a thickness of about 1 mm are then pressed against the substrate from the outside through the intermediary of Teflon sheets 18, preferably in a reduced pressure atmosphere (see FIG. 12). The pressure applied from the stainless plates 19 easily deforms the resin layers 16. That is, the resin laminated onto the circuit patterns 15 flows so as to fill the spaces between the circuit patterns. The substrate as a whole is made into an almost flat configuration. The resin concentrated beforehand on the resin sheets is also forced into the interior of the through holes so that the interior of the through holes is thoroughly filled with resin. Further, the pressing of the stainless plates 19 thinly spreads the resin sheets 20 as a whole. Air bubbles, which may have entered spaces between the resin sheets 20 and the substrate, and air bubbles within the resin layers 16, rise up to the vicinity of the surface of the resin layers 16. Consequently, the air bubbles are substantially removed from the interior of the resin. The resin layers 16 are then heated so as to be finally cured.

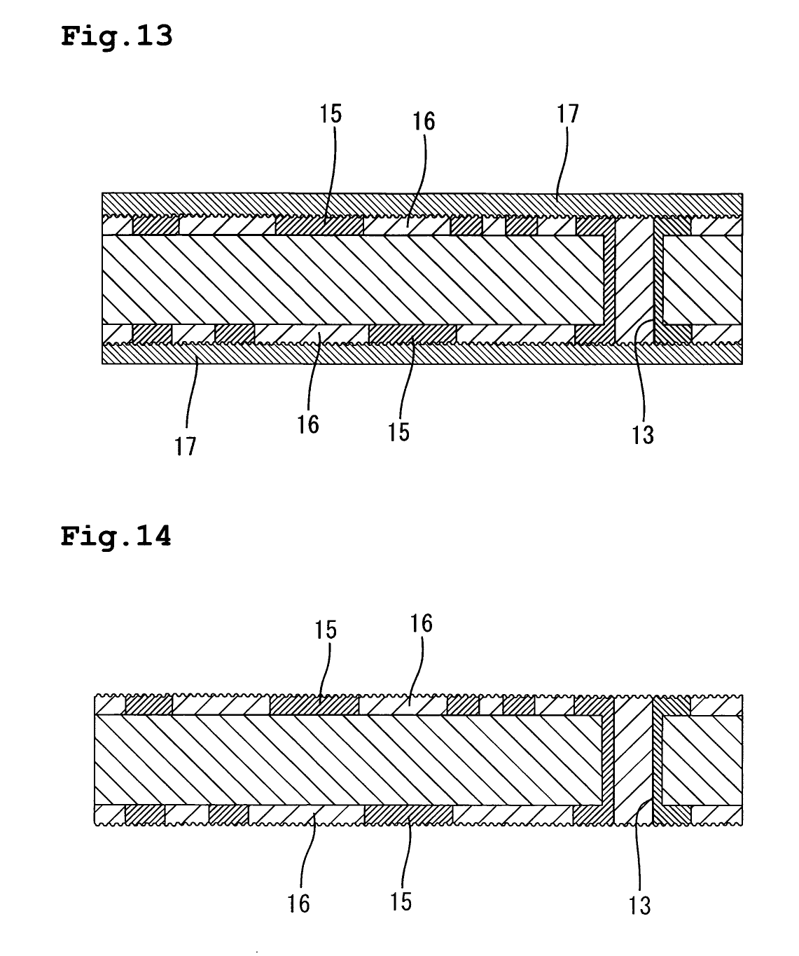

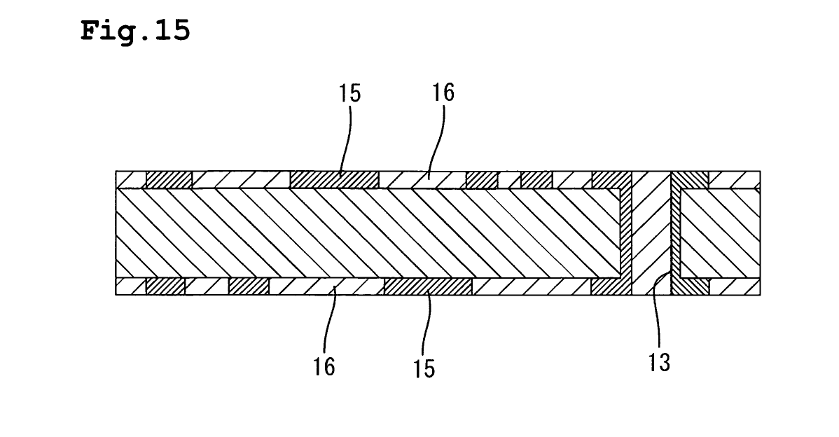

The stainless plates 19 are subsequently removed. The nickel foils 17 adhered to the surface of the resin layers 16 may be removed by an etching solution exclusively used for nickel (see FIGS. 13 and 14). The resin layers 16 on the circuit patterns 15 are thinly compressed to a thickness of about 10 μm. Finally, as in the first embodiment, polishing is performed in order to expose the circuit patterns 15 and to obtain a flat substrate (see FIG. 15).

The present invention is not limited to the embodiments or combinations of the embodiments described above with reference to the drawings. The following embodiments are also included within the scope of the present invention. Further various variations other than the following embodiments are also possible within the scope and spirit of the invention.

(1) In the above described embodiments, the circuit patterns are formed by the subtractive method. However, the circuit patterns may also be formed by an additive method.

(2) In the above described embodiments, thermosetting epoxy resin is used as the material of the resin layers. However, the embodiment is not limited to this material. A thermosetting resin, such as a urea resin, a melamine resin, a phenol resin, an acrylic resin, and an unsaturated polyester resin may also be used.

(3) In the above described embodiments, nickel is used as the metallic foil material. However, the embodiments are not limited to this material. Other metals, such as copper, may also be used for the metallic foil.

### INDUSTRIAL APPLICABILITY

As described above, according to the present invention a printed wiring board formed with a resin layer having uniform and advantageous characteristics throughout the wiring board may be manufactured, regardless of the sparseness or density of the sections of circuit patterns and the presence or absence of through holes.

1. A method for manufacturing a flat printed wiring board, including the steps of:
Obtaining a printed wiring board with a circuit pattern formed on a surface of the printed wiring board;
forming a resin layer by superposing a semi-cured resin sheet on the surface of the printed wiring board containing said circuit patterns, with complementary resin circuit patterns formed on the semi-cured resin sheet;
pressing and forcing the resin layer into spaces between said circuit patterns;
curing said resin layer; and
polishing said cured resin layer, thereby exposing said circuit patterns,
wherein said semi-cured resin sheet with said complementary resin circuit patterns complementary to said circuit patterns are included on a surface of said semi-cured resin sheet facing said circuit patterns.

2. A method for manufacturing a flat printed wiring board, including the following steps:
forming a resin layer by superposing a semi-cured resin sheet on a printed wiring board where through holes and circuit patterns are formed;
pressing and forcing the resin layer into spaces between said circuit patterns;
curing said resin layer; and
polishing the cured resin layer, thereby exposing said circuit patterns;
wherein additional resin for filling said through holes is included at locations of said semi-cured resin sheet corresponding to said through holes.

3. The method for manufacturing the flat printed wiring board according to claim 1, wherein the pressing against said resin layer is performed in a reduced pressure atmosphere.

4. The method for manufacturing the flat printed wiring board according to claim 3 wherein a metallic foil with a roughened surface facing said resin layer is superposed and pressed on said resin layer.

5. The method for manufacturing the flat printed wiring board according to claim 4 wherein said metallic foil is formed with a metal of a different kind than said circuit patterns.

6. The method for manufacturing the flat printed wiring board according to claim 5 wherein said metallic foil is formed from a nickel material.

7. The method for manufacturing the flat printed wiring board according to claim 6 wherein said semi-cured resin sheets are formed from a thermosetting epoxy resin.

8. The method for manufacturing the flat printed wiring board according to claim 6 wherein said semi-cured resin sheets are formed from a thermosetting resin.

9. The method for manufacturing the flat printed wiring board according to claim 2 wherein the pressing against said resin layer is performed in a reduced pressure atmosphere.

10. The method for manufacturing the flat printed wiring board according to claim 9 wherein a metallic foil with a roughened surface facing said resin layer is superposed and pressed on said resin layer.

11. The method for manufacturing the flat printed wiring board according to claim 10 wherein said metallic foil is formed with a metal of a different kind than said circuit patterns.

12. A method for manufacturing a flat printed wiring board, including the steps of:
forming a resin layer by superposing a semi-cured resin sheet on a printed wiring board where through holes and circuit patterns are formed;
pressing and forcing the resin layer into spaces between said circuit patterns and into said through holes;
curing said resin layer; and
polishing said cured resin layer, thereby exposing said circuit patterns,
wherein said semi-cured resin sheet includes complementary resin circuit patterns complementary to said circuit patterns on a surface of said semi-cured resin sheet facing said circuit patterns, and
wherein said semi-cured resin sheet further includes additional resin on said surface of said semi-cured resin sheet facing said circuit patterns at locations corresponding to positions of said through holes.

13. The method for manufacturing the flat printed wiring board according to claim 12, wherein the step of pressing against said resin layer is performed in a reduced pressure atmosphere.

14. The method for manufacturing the flat printed wiring board according to claim 13 wherein a metallic foil with a roughened surface facing said resin layer is superposed onto said resin layer prior to the step of pressing.

15. The method for manufacturing the flat printed wiring board according to claim 14 wherein said metallic foil is formed with a metal of a different kind than said circuit patterns.

16. The method for manufacturing the flat printed wiring board according to claim 15 wherein said metallic foil is formed from a nickel material.

17. The method for manufacturing the flat printed wiring board according to claim 16 wherein said semi-cured resin sheets are formed from a thermosetting epoxy resin.

18. The method for manufacturing the flat printed wiring board according to claim 16 wherein said semi-cured resin sheets are formed from a thermosetting resin.

19. The method for manufacturing the flat printed wiring board according to claim 12 wherein said circuit patterns are formed by a subtractive method.

20. The method for manufacturing the flat printed wiring board according to claim 1 wherein said circuit patterns are formed by a subtractive method.
